(19) United States
(12) Patent Application Publication
(10) Pub. No.: US 2010/0198829 A1
(43) Pub. Date: Aug. 5, 2010

(54) METHOD AND COMPUTER-PROGRAM PRODUCT FOR RANGED INDEXING

(76) Inventor: D. Blair Elzinga, Albany, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/363,222

(22) Filed: Jan. 30, 2009

(51) Int. Cl. G06F 17/30

(52) U.S. Cl. 707/741; 707/E17.017

(57) ABSTRACT

A method for generating and searching a ranged index provides a computer-readable medium which is adapted to store a database including a data chunk, and a ranged index including a data chunk index; generating the data chunk index by determining a high value in the data chunk and a low value in the data chunk; generate the ranged index from such data chunk index; and storing the ranged index on the computer-readable medium. A search value or values may then be provided; comparing the search value or values to the high value and the low value from the data chunk index for the data chunk in the ranged index for the database; and searching the data chunk to determine if the search value or values is lower than or equal to the high value and higher than or equal to the low value. By using inexpensive, quick comparisons of minima and maxima, the method and computer-program product avoids more costly sequential searches of larger data chunks where possible.

### BACKGROUND

In some data storage environments, a database may be stored in data chunks. The data chunks may be separated from each other physically, through the use of file structure, or may be abstractions in a contiguously stored database. For example, a database may be stored using multiple compressed files, each representing a data chunk, which may reside on the same physical computer-readable medium, such as, for example, a single hard drive, or multiple computer-readable mediums connected by a network, such as, for example, multiple hard drives in a server farm. Or, a database may be stored using multiple backup tapes, with each backup tape representing a data chunk. It may also be possible to combine physical and file structure separation of the data chunks, for example, by storing a database in multiple compressed files spread across multiple backup tapes, where each compressed file may represent a data chunk.

Performing searches on a database that has been divided into discrete data chunks may be time and resource intensive. Databases divided into data chunks may only permit sequential access to data. For example, if a database has been stored using multiple compressed files, searching through the database may require the decompression of every compressed file in the database.

The use of indexes may reduce the time and resources needed to search through a database. Current methods of indexing data provide ways of reducing the time and resources required to perform searches on databases in which direct access to data is permitted. B-tree indexing, for example, is a well-known indexing method in the art of database management and searching for databases that permit direct access to data.

### BRIEF DESCRIPTION OF THE DRAWINGS

Embodiments will now be described in connection with the associated drawings, in which:

FIG. 1 depicts an exemplary ranged index for a database.

FIG. 2 depicts an exemplary ranged index with categories for a database.

FIG. 3 depicts an exemplary flowchart for creating a ranged index for a database.

FIG. 4 depicts an exemplary flowchart for creating a ranged index with categories for a database.

FIG. 5 depicts an exemplary flowchart for searching a database using a ranged index.

FIG. 6 depicts an exemplary flowchart for searching a database using a ranged index with categories.

### DETAILED DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without departing from the spirit and scope of the embodiments. It is to be understood that each specific element includes all technical equivalents that operate in a similar manner to accomplish a similar purpose. The examples and embodiments described herein are non-limiting examples.

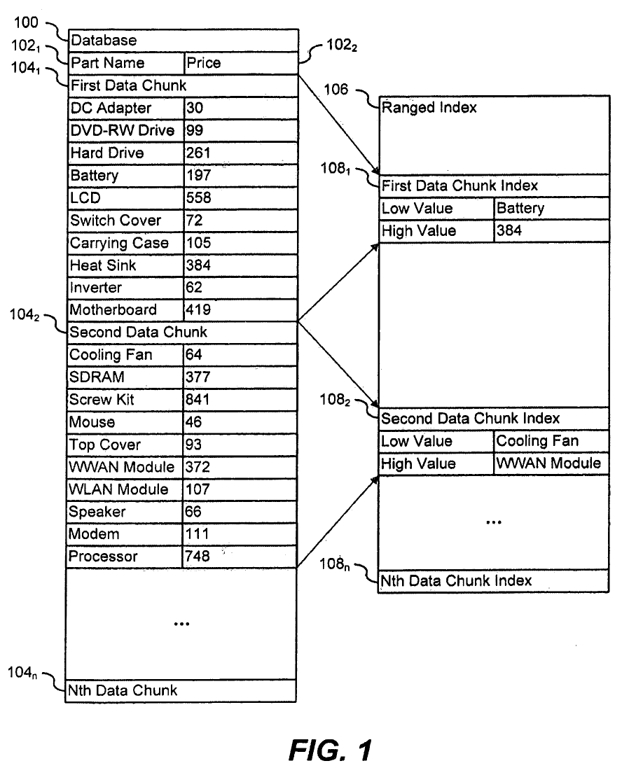

FIG. 1 depicts an exemplary ranged index for a database. A database 100 may include data stored in any number of entries. An entry may have any number of fields, and a field may have a category. The category for a field may indicate the type of information represented by a value stored in the field. For example, an entry in the database 100 may have two fields, where the first field has a first category 102₁, “part name”, and the second field has a second category 102₂, “price.” The database 100 may be divided into a plurality of data chunks 104₁, 104₂, . . . 104ₙ, for example, data chunk 104₁ and data chunk 104₂ as shown in FIG. 1 A ranged index 106 may be generated for the database 100 by, for example, any particular data chunk in the database 100, searching for a low value and a high value stored in any field in the data chunk, and storing the low value and the high value in a data chunk index 108₁, 108₂, . . . 108ₙ of the ranged index 106. This may be repeated for other data chunks in the database 100. For example, the ranged index 106 may include a first data chunk index 108₁ and a second data chunk index 108₂, which may include the high value and the low value found in the data chunk 104₁ and the data chunk 104₂, respectively. When the database 100 is searched for a search value, the ranged index 106 may be used to determine which, if any, of the data chunks 104₁, 104₂, . . . 104ₙ included in the database 100, may include the search value. If the search value is higher than the high value or lower than the low value in the data chunk index for a particular data chunk 104₁, 104₂, . . . 104ₙ, then logically the search value will not be found in the data chunk, and the data chunk does not need to be searched.

The database 100 may be any database of any type or format, and may include any type of data. Any suitable computer-readable medium may be used to store the database 100, including, for example, hard drives, magnetic tape, optical media and flash memory. Data may be stored in the database 100 in entries; an entry may have any number of fields. The database 100 may be divided into any number of data chunks 104₁, 104₂, . . . 104ₙ. For example, the database 100 may be stored as a single data chunk, or may be stored as multiple data chunks including equal or varying numbers of entries.

The first category 102 and the second category 103 may be data stored in or otherwise linked to the database 100 indicating the type of information represented by values stored in the fields of the entries of the database 100. The first category 102₁ of the database 100 may indicate that the data stored in the fields associated with the first category 102₁ represents a “part name,”, for example, the name of a replacement part for a laptop computer. The second category 102₂ may indicate that the data stored in the fields associated with the second category 102₂ represents a “price,”, for example, the price of the replacement part whose “part name” is in the same entry. For example, the first entry in the database 100 has a “part name” of “Battery” and a “price” of “30.”

The first data chunk 104₁ and the second data chunk 104₂ may be data chunks into which the database 100 has been divided. The first data chunk 104₁ and the second data chunk 104₂ may be, for example, separate compressed files stored on the same computer-readable medium or physically separate computer-readable mediums. Or, as another example, the first data chunk 104₁ and the second data chunk 104₂ may be uncompressed data stored on separate computer-readable mediums. Any suitable computer-readable medium may be used to store first data chunk 104₁ and the second data chunk 104₂.

For example, the first data chunk 104ᵢ may be uncompressed data stored on a magnetic backup tape in a first tape drive, and the second data chunk 104₂ may be uncompressed data stored on a magnetic backup tape in a second tape drive. Or, the first data chunk 104₁ may be stored in a first compressed file such as, for example, a zip file, a rar file, an ace file, an arj file, a tgz file, etc. on a hard drive, and the second data chunk 104₂ may be stored as a second compressed file on the same hard drive. Any other suitable computer-readable mediums and compression methods may be used for the storage of the plurality of data chunks 104₁, 104₂, . . . 104ₙ.

Entries in the first data chunk 104₁ and the second data chunk 104₂ may be sequentially accessible or directly accessible. An entry that is sequentially accessible may only be accessed by first accessing all preceding entries in the data chunk. For example, if the first data chunk 104₁ is stored in a compressed file, the entries in the first data chunk 104₁ may be sequentially accessible but not directly accessible. To access the entry with the “part name” of “LCD”, the four preceding entries may need to be accessed first.

The ranged index 106 may be an index for the database 100 which may store, or provide a link or pointer to, one of a plurality of data chunk indexes 108₁, 108₂, . . . 108ₙ for a corresponding data chunk 104₁, 104₂, . . . 104ₙ in the database 100. When a search for a search value is performed on the database 100, the ranged index 106 may be checked first to determine which, if any, of the data chunks 104₁, 104₂, . . . 104ₙ included in the database 100 may include the search value. The ranged index 106 may be stored on any suitable computer-readable medium, and may be stored on the same computer-readable medium as the database 100 or either of the first data chunk 104₁ or the second data chunk 104₂, or may be stored on a separate computer-readable medium. If the data chunks 104₁, 104₂, . . . 104ₙ of the database 100 are stored on separate computer-readable mediums, a copy of the ranged index 106 may be stored on the separate computer-readable mediums as well, or the ranged index 106 may be divided among the separate computer-readable mediums. For example, the database 100 may be stored on slower, cheaper computer-readable medium such as a hard drive, while the ranged index 106 may be stored on a faster computer-readable medium, such as a solid-state drive.

The first data chunk index 108₁ and the second data chunk index 108₂ may be indexes for, and may store the high values and low values from, the first data chunk 104₁ and the second data chunk 104₂, respectively. The first data chunk index 108₁ and the data chunk index 108₂, or links or pointers thereto, may be stored in the ranged index 106 in any suitable manner. For example, the first data chunk index 108₂ and the second data chunk index 108₂ may be stored in a single file that is the ranged index 106. Alternatively, the ranged index 106 may include links or pointers to the first data chunk index 108₁ and the second data chunk index 108₂. For example, if the first data chunk 104₁ and the second data chunk 104₂ are stored on separate computer-readable mediums, the first data chunk index 108₁ and the second data chunk index 108₂ may be stored on the separate computer-readable mediums with their corresponding data chunk 104₁, 104₂, and the ranged index 106 may include links or pointers to the first data chunk index 108₁ and the second data chunk index 108₂.

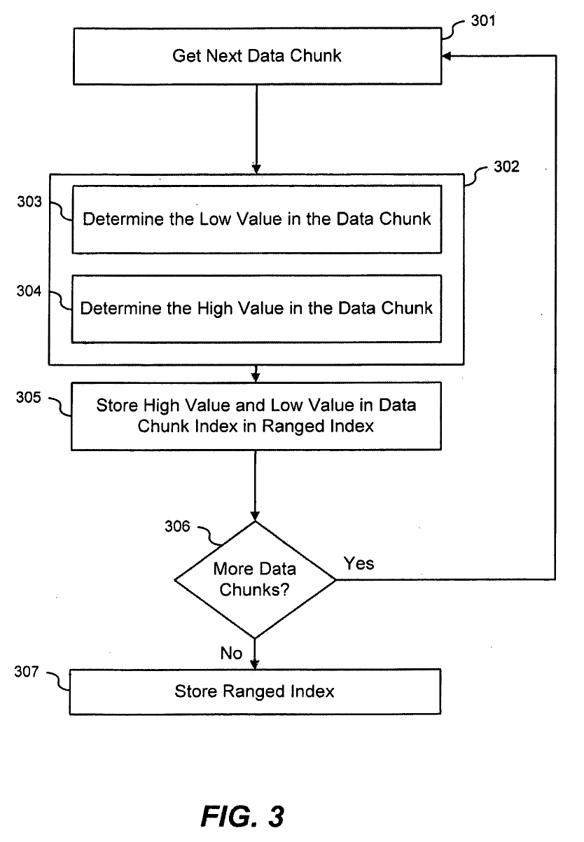

FIG. 3 depicts an exemplary flowchart for creating a ranged index for a database, and will be discussed with reference to FIG. 1. In block 301, the next data chunk available in the database 100 may be retrieved for processing. For example, if no data chunks from the database 100 have been processed, the first data chunk in the database 100, data chunk 104₁, may be retrieved. If the data chunk 104₁ has already been processed, then next data chunk may be the second data chunk 104₂. Data chunks may be retrieved in any order by block 301, for example, the second data chunk 104₂ may be retrieved and processed before the first data chunk 104₁, or data chunks may be processed in parallel. A data chunk may be retrieved by block 301 for processing the first time the data chunk is read. For example, if there is no data chunk index 108₁ for the data chunk 104₁, the first data chunk 104₁ may be retrieved by block 301 for processing the first time the first data chunk 104₁ is accessed for any other reason. If a data chunk index is created for a data chunk only when the data chunk is first accessed, the result may be a database having a ranged index in which some data chunks have data chunk indexes and some do not.

In block 302, the low value and the high value in the data chunk retrieved in block 301 may be determined. In block 303, the low value may be determined, and in block 304 the high value may be determined. Any suitable searching or sorting algorithm may be used to determine the low value and the high value in the data chunk. For example, the low value and the high value may be determined while the data is being read for the first time. Block 303 and block 304 may be performed simultaneously, or they may be performed sequentially, depending on the algorithm used. Comparison between values in the fields of the retrieved data chunk may be lexicographic, alphanumeric, or numeric. For example, a linear search algorithm may do lexicographic comparisons on the values in the fields of the first data chunk 104₁, to determine the high value and the low value. The lexicographic low value in the first data chunk 104₁ may be “Battery”, and the lexicographic high value may be “384” (“three-hundred-eighty-four”).

In block 305, the high value and the low value determined in block 302 may be stored in the data chunk index for the processed data chunk. For example, the high value “384” and the low value “Battery” for the first data chunk 104₁ may be stored in the first data chunk index 108₁ from the ranged index 106. The high value and low value may be written to the first data chunk index 108₁ on a computer-readable medium, or may be stored in non-persistent memory, such as, for example, RAM, and be written to a computer-readable medium at a later time, such as, for example, after all other data chunks in the database 100 have been processed.

In block 306, if there are more data chunks left to process in the database 100, flow proceeds back to block 301. Otherwise, flow proceeds to block 307.

In block 307, the ranged index 106 may be stored. The ranged index 106 may include the data chunk indexes for the processed data chunks from the database 100. For example, if the first data chunk 104₁ and the second data chunk 104₂ have been processed, the ranged index 106 may include the first data chunk index 108₁ and the second data chunk index 108₂. The ranged index 106 may be stored on any suitable computer-readable medium in any suitable manner, as described above.

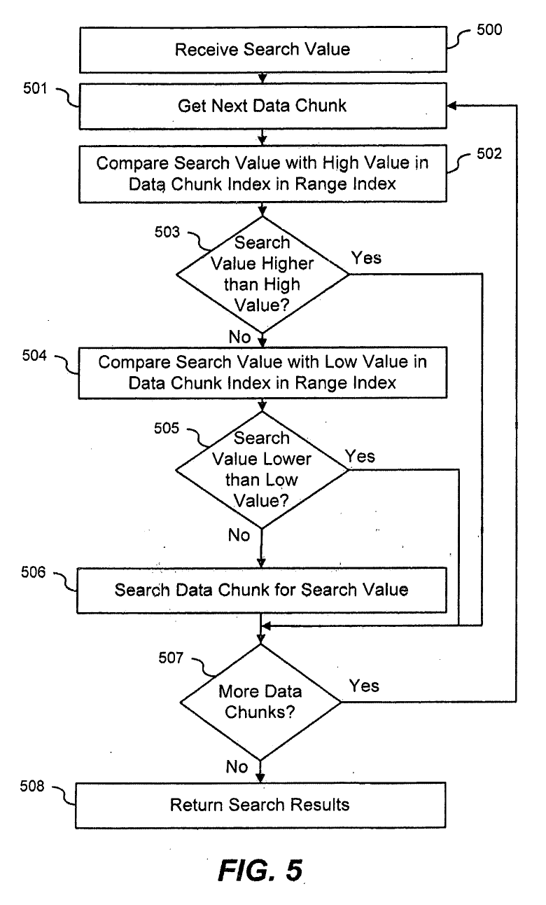

FIG. 5 depicts an exemplary flowchart for searching a database using a ranged index, and will be discussed with reference to FIG. 1.

In block 500, a search value may be received. The search value may be received from any suitable party, such as, for example, a user of a computer system, another computer system, a program running on the computer system performing the search, etc. The search value may be a single value, for example, a single word, phrase, or number. Multiple search values may be received in block 500, such as, for example, a search string including multiple search values connected by logical operators. In the case of multiple search values, each search value may be searched for separately, and the logical operators may be applied to the results of each separate search after.

The search value or values (collectively referred to as “search criteria”) may themselves be ranged as if the search criteria were itself a database chunk. Then, the range criteria of the search “chunk” can be compared as a whole with the database. A combination of this grouping and checking of individual ranges and applying logical operators as described immediately herein above would be a matter of choice in any particular implementation. Thus, this concept of ranging the search input before searching may be most useful when applied to a large number of search values.

In block 501, the next data chunk available in the database 100 may be retrieved for processing. For example, if no data chunks from the database 101 have been processed, the first data chunk in the database 100, data chunk 104₁, may be retrieved. If the first data chunk 104₁ has already been processed, then next data chunk may be the second data chunk 104₂. Data chunks may be retrieved in any order by block 501, for example, the second data chunk 104₂ may be retrieved and processed before the first data chunk 104₂.

In block 502, the search value may be compared with the high value from the data chunk index for the data chunk retrieved in block 501. The comparison may be done lexicographically, alphanumerically, or numerically, which may depend on the type of comparison that was used to find the high value in the data chunk. For example, if the first data chunk 104₁ is being processed, the high value of “384” may be identified from the first data chunk index 108₁ from the ranged index 106. If the high value of “384” was determined lexicographically, the search value may be compared lexicographically with “384” to determine whether the search value is higher.

In block 503, if the search value is higher than the high value in the data chunk index for the data chunk retrieved in block 501, flow proceeds to blocks 507 and that data chunk may not be searched for the search value. Otherwise, flow proceeds to block 504. For example, if the search value is “Top Cover”, a lexicographic comparison may determine that “Top Cover” is higher than “384.” Because “Top Cover” is higher than the high value in the first data chunk index 108₁, the first data chunk 104₁ may not be searched for the value “Top Cover,” as it may not contain any values higher than the high value of “384.” In this case, flow would proceed to block 507. If the search value were “Mouse” instead of “Top Cover”, flow would proceed to block 504, as “Mouse” is not higher than “384.”

In block 504, the search value may be compared with the low value from the data chunk index for the data chunk retrieved in block 501. The comparison may be similar to that in block 502. For example, if the first data chunk 104₁ is being processed, the low value of “Battery” may be identified from the first data chunk index 108₁ from the ranged index 106. If the low value of “Battery” was determined lexicographically, the search value may be compared lexicographically with “Battery” to determine whether the search value is lower.

In block 505, if the search value is lower than the low value in the data chunk index for the data chunk retrieved in block 501, flow proceeds to blocks 507 and that data chunk may not be searched for the search value. Otherwise, flow proceeds to block 506. For example, if the search value is “AC Adapter”, a lexicographic comparison may determine that “AC Adapter” is lower than “Battery.” Because “AC Adapter” is lower than the low value in the first data chunk index 108₁, the data chunk 104₁ may not be searched for the value “AC Adapter” as the data chunk 104₁ may not contain any values lower than the low value of “Battery.” In this case, flow would proceed to block 507. If the search value were “Mouse” instead of “AC Adapter”, flow would proceed to block 506, as “Mouse” is not lower than “Battery.”

In block 506, the data chunk retrieved in block 501 may be searched for the search value. Any suitable search algorithm may be used to determine if there one or more matches for the search value in the data chunk. The results of this search may be stored in any suitable manner such that the results may be returned to any party designated to receive the results, such as, for example, the party from whom the search value was received in block 501. For example, a linear search algorithm may be used to determine if there is a match for the value “Mouse” in the first data chunk 104₁. The linear search algorithm may compare the search value to the values in the fields of the entries of the first data chunk 104₁ sequentially, until all of the fields have been searched. If the first data chunk 104₁ is stored in a compressed file, it may need to be uncompressed to memory or a computer-readable medium before or while being searched.

In block 507, if there are more data chunks left to process in the database 100, flow proceeds back to block 501. Otherwise, flow proceeds to block 508.

In block 508, the search results may be returned to any suitable party in any suitable manner. If a match for the search value was found in the database 100, the returned search results may indicate how many matches were found, which of the data chunks the matches were found in, and all or a portion of the entries in which the matches were found. For example, if the database 100 was searched with a search value of “SDRAM,” the search results may indicate that the entry “SDRAM 377” was found in the second data chunk 104₂.

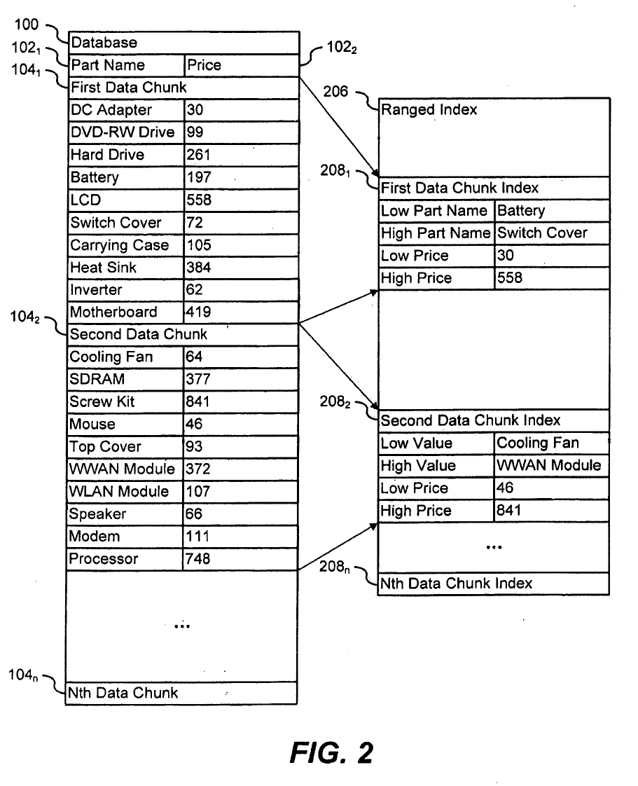

In one exemplary embodiment, the ranged index 106 may be generated based on categories in the database 100. FIG. 2 depicts an exemplary ranged index with categories for a database.

The database 100 of FIG. 2 is the same as the database 100 in FIG. 1. The ranged index 206 differs from the ranged index 106. The ranged index 206 includes the first data chunk index 208₁ and the second data chunk index 208₂. Instead of a high value and a low value, as in the first data chunk index 108₁ of FIG. 1, the first data chunk index 208₁ stores a high part name and a low part name, for the first category 102₁, and a high price and a low price, for the second category 102₂. The second data chunk index 208₁₂ stores similar data.

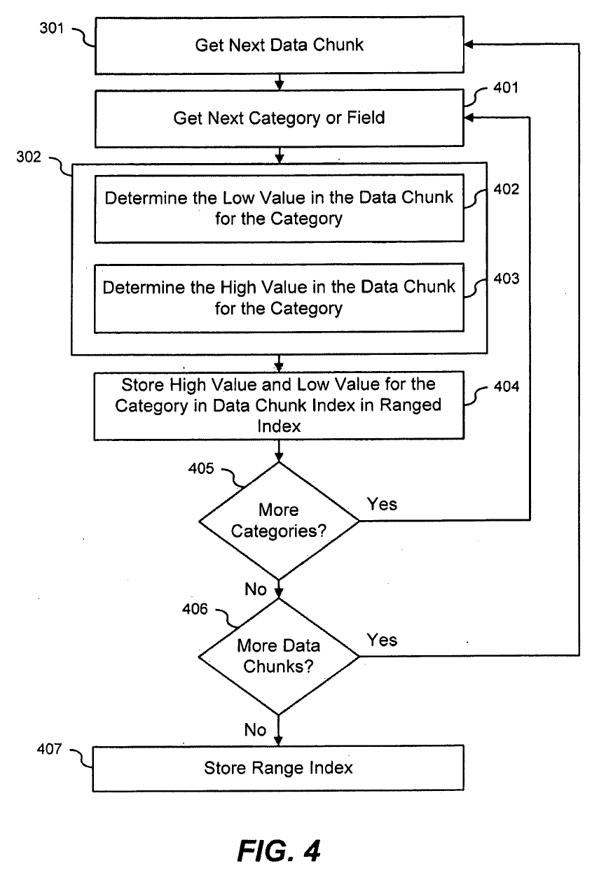

FIG. 4 depicts an exemplary flowchart for creating a ranged index with categories for a database, and will be discussed with reference to FIG. 2. Blocks 301, 302, 306 and 307 may operate in the same manner as in FIG. 3.

In block 401, the next category in the data chunk retrieved in block 301 may be selected. For example, if no categories from the data chunk 1 104 have been selected, the first category 102₁, “part name”, in the data chunk 1 104, may be selected. If the first category 102₁ has already been processed, the next category may be the second category 102₂, “price.” Categories may be selected in any order by block 401, for example, the second category 102₂ may be selected and processed before the first category 102₁.

In block 402 and block 403, the low value and the high value for the selected category in the retrieved data chunk may be determined. Block 402 and block 403 may operate similarly to blocks 303 and 304. However, the fields searched or sorted to determine the high value and the low value in blocks 402 and 403 may only be those fields associated with the category selected in block 401. For example, if the first data chunk 104₁ from the database 100 was retrieved in block 301, and the first category 102₁ “part name” was selected in block 401, block 402 and block 403 may determine the high value and the low value based on the fields associated with the first category 102₁. The high value may be “Switch Cover” and the low value may be “DC Adapter.” Although “384” is higher than “Switch Cover”, “384” is not associated with the selected category, the first category 102₁, and therefore may not be the high value for the first category 102₁. The searching or sorting may be alphanumeric, lexicographic, or numeric, as in block 304. The data type of the values stored in the fields associated with the selected category may indicate which type of searching or sorting may be appropriate, although any type of searching or sorting may be applied to any data type. For example, the fields associated with the first category 102₁ may be strings, as they are the names of parts, and may be searched or sorted lexicographically, The fields associated with the second category 102₂ may be integers, as they are prices, and may be searched or sorted numerically.

In block 404, the high value and the low value determined in block 302 may be stored in the data chunk index for the processed data chunk, based on the category selected in block 401. The data chunk index for the processed data chunk may be stored in, or pointed or linked to by, the ranged index 206. Block 404 may operate similarly to block 305, except that the data chunk index may include high values and low values classified by category. For example, the high value “Switch Cover” and the low value “Battery” for the first data chunk 102₁, for the first category 102₁, may be stored in the first data chunk index 208₁ from the ranged index 206, and may be classified based on the first category 102₁, “part name.” If the second category 102₂ “price” is selected after the first category 102₁, the high value and low value for the second category 102₂ may also be stored in the first data chunk index 208₁ from the ranged index 206. The high value and low value for the second category 102₂ may be determined numerically, resulting in a high value of “558” and a low value of “30”.

In block 405, if there are more categories in the data chunk being processed, flow proceeds back to block 401. Otherwise flow proceeds to block 306.

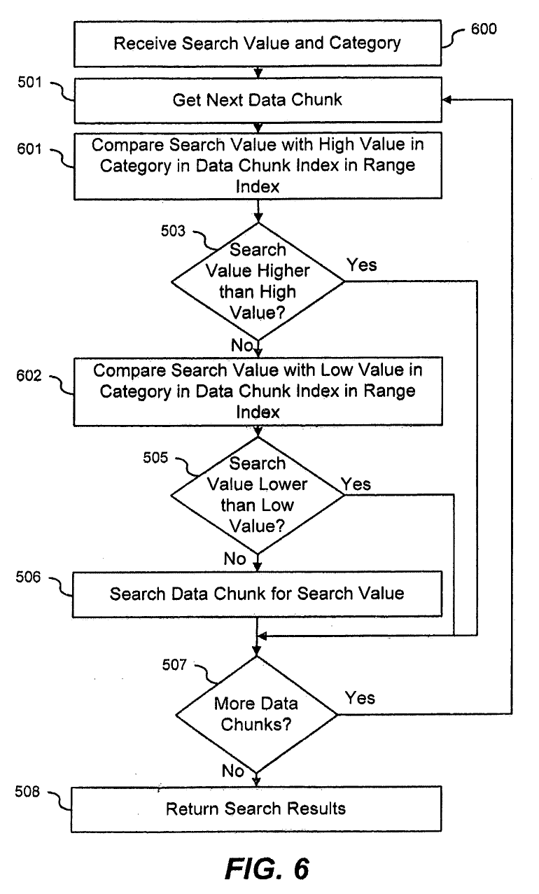

FIG. 6 depicts an exemplary flowchart for searching a database using a ranged index with categories, and will be discussed with reference to FIG. 2. Blocks 501, 503, 505, 506, 507 and 508 are the same as in FIG. 5.

In block 600, a search value may be received, similarly to block 500. A category may also be received along with the search value. The category may correspond to one of the categories in the database 100. For example, the search value “Modem” may be received with the category “part name,” corresponding to the second category 102₂ in the database 100. A search value may be received in block 600 without a category, or with multiple categories. If multiple categories are received, the multiple categories may be used one at a time with search value in blocks 601 and 602. If no categories are received with the search value, an error may be generated, or, as an option, the search may be performed as if all categories from the ranged index 206 had been received with the search value. For example, if the search value “Mouse” is received without a category for a search on the database 100, the search may be performed using the first category 102₁ and the second category 102₂.

In block 601, the search value may be compared with the high value in the category from the data chunk index for the data chunk being processed. Block 601 may operate similarly to block 502, except that the search value may be compared with the high value for the category for the data chunk, as received in block 600. For example, if the first data chunk 104₁ is being processed, the search value is “Mouse”, and the category is the first category 102₁ “part name,” the high value “Switch Cover” may be identified for the first category 102₁ “part name” in the first data chunk index 208₁ from the ranged index 206.

In block 602, the search value may be compared with the low value in the category from data chunk index for the data chunk being processed. Block 602 may function similarly to block 601, except using the low value in the category instead of the high value in the category.

In another exemplary embodiment, a ranged index may be a combinations of the ranged index 106 and the ranged index 206, which may allow for searching with or without a category.

In another exemplary embodiment, when a database is updated, the database's ranged index may be updated. If a new entry were added to the first data chunk 104₁ in the database 100, the first data chunk index 108₁ from the ranged index 106 may be updated. When the new entry is added in to the database 100, the values in the fields of the new entry may be compared to the high value and the low value in the first data chunk index 108₁. If the a value in the new entry is higher than the high value, or lower than the low value, the value may be placed into the first data chunk index 108₁. For example, if the new entry included a “part name” of “Touchpad” and a “price” of “400”, both “Touchpad” and “500” may be compared with the high value of “384” and the low value of “Battery.” Since the high value and the low value were determined lexicographically, the comparison may be lexicographical. “Touchpad” is higher than the high value of “384”, and may be placed into the first data chunk index 108₁ from the ranged index 106 as the high value, replacing “384.” Updating the ranged index 206, which includes categories, may be similar, except that the category of the values in the new entry may determine which high value and low value the values are compared with from the ranged index 206.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

While various exemplary embodiments have been described above, it should be understood that they have been presented by way of example only, and not limitation. For example, it should be understood that the “equality” type of logical operator described herein above is not the only logical operator that works with range indexing. It works equally well with the following: less-than, less-than-or-equal, greater-than, greater-than-or-equal. Range indexing may not be particularly beneficial for inequality searches. Thus, the breadth and scope of the present invention should not be limited by any of the above-described exemplary embodiments, but should instead be defined only in accordance with the following claims and their equivalents.

What is claimed is:

1. A method for generating and searching a ranged index, comprising;
providing a computer-readable medium which is adapted to store a database comprising a data chunk, and a ranged index comprising a data chunk index;
generating said data chunk index by determining a high value in the data chunk and a low value in the data chunk;
generate the ranged index from said data chunk index; and
storing the ranged index on the computer-readable medium; and
providing a search value;
comparing said search value to said high value and said low value from said data chunk index for the data chunk in the ranged index for the database; and
searching the data chunk to determine if said search value is lower than or equal to said high value and higher than or equal to said low value.

2. A method for generating a ranged index for a database including one or more data chunks, comprising:
determining a highest value from at least one of the one or more data chunks;
determining a lowest value from at least one of the one or more data chunks; and
storing said highest value and said lowest value in the ranged index as a data chunk index for each of said one or more data chunks.

3. The method of claim 2, wherein:
each of said one or more data chunk comprises a category;
determining said highest value from said category for each of said one or more data chunks;
determining said lowest value from said category for each of said one or more data chunks; and
storing said highest value and said lowest value in the ranged index as said data chunk index based on said category for each of said one or more data chunks.

4. A computer-readable medium comprising instructions, which when executed by a computer system causes the computer system to perform operations for generating a ranged index for a database comprising a data chunk, the computer-readable medium comprising:
instructions for determining a highest value from the data chunk;
instructions for determining a lowest value from the data chunk; and
instructions for storing said highest value and said lowest value in the ranged index as a data chunk index.

5. The computer-readable medium of claim 4, wherein:
the data chunk comprises a category;
instructions for determining a highest value from the data chunk further comprise instructions for determining said highest value from said category;
instructions for determining a lowest value from the data chunk further comprise instructions for determining said lowest value from said category; and
instructions for storing said highest value and said lowest value in the ranged index as said data chunk index further comprise instructions for storing said highest value and said lowest value based on said category.

6. The computer-readable medium of claim 4, wherein the data chunk is a compressed file.

7. The computer-readable medium of claim 4, wherein said instructions for determining said highest value and determining said lowest value are based on at least one of lexicographical values, alphanumerical values, and numerical values.

8. The computer-readable medium of claim 4, wherein instructions for storing said highest value and said lowest value in the ranged index as said data chunk index use at least one of a link and a pointer from the ranged index to said data chunk index.

9. A computer-readable medium comprising instructions, which when executed by a computer system causes the computer system to perform operations for searching a ranged index for a database comprising a data chunk, the computer-readable medium comprising:
instructions for receiving a search value;
instructions for comparing said search value to a high value and a low value from a data chunk index for the data chunk in the ranged index for the database;
instructions, if said search value is lower than or equal to said high value and higher than or equal to said low value, for searching the data chunk for said search value to generate a search result; and
instructions for returning said search result.

10. The computer-readable medium of claim 9, wherein:
the data chunk comprises a category;
instructions for receiving said search value further comprise instructions for receiving said category; and
wherein said low value and said high value from the data chunk index for the data chunk in the ranged index for the database are from said category.

11. The computer-readable medium of claim 9, wherein the data chunk is a compressed file.

12. The computer-readable medium of claim 9, wherein said compressed file is uncompressed if said search value is lower than or equal to said high value and higher than or equal to said low value.
